(19) United States
(12) Patent Application Publication
(10) Pub. No.: US 2009/0212577 A1
(43) Pub. Date: Aug. 27, 2009

(54) Vehicle door lock device

(75) Inventors: Katsutoshi Fukunaga, Aichi-ken (JP); Makoto Suzumura, Aichi-ken (JP); Takashi Nishio, Aichi-ken (JP); Akira Muramatsu, Aichi-ken (JP); Shigeru Tanabe, Aichi-ken (JP)

Correspondence Address: BUCHANAN, INGERSOLL & ROONEY PC, POST OFFICE BOX 1404, ALEXANDRIA, VA, 22313-1404, US

(73) Assignee: Aisin Seiki Kabushiki Kaisha, Kariya-shi (JP)

(21) Appl. No.: 11/658,768

(22) PCT Filed: Aug. 18, 2005
(86) PCT No.: PCT/JP05/15388

§ 371 Date: Jan. 30, 2007

(30) Foreign Application Priority Data
Aug. 19, 2004 (JP) 2004-239980

(51) Int. Cl. E05B 65/12

(52) U.S. Cl. 292/216; 70/239

(57) ABSTRACT

A door lock device for a vehicle has a latch mechanism (3) configured to be fixed to a mounting surface (1a) of an end portion of a vehicle door for maintaining the vehicle door in a closed position relative to a vehicle body, said latch mechanism (3) having a latch (32) defining a latch plane; and an operational lever (56) operatively linked to an operational handle (12) provided to the vehicle door and being operatively linked to the latch mechanism for operating the latch mechanism for releasing the vehicle door from the vehicle body; characterized by a locking lever (72) arranged perpendicular to the latch plane such that a side surface of the locking lever (72) faces toward the side panel of the vehicle door, the locking lever operable to allow and disallow operable linkage between the operational lever and the latch mechanism; an emergency operational member (76) arranged to face toward the side panel of the vehicle door and operatively linked to the locking lever; an active lever (71) arranged perpendicular to the latch plane such that a side surface of the active lever (71) faces toward the side panel of the vehicle door and including an output shaft (71a) that supports the locking lever and the emergency operational member; and an electric motor (73) operatively linked to the active lever for operating the locking lever via the active lever.

### TECHNICAL FIELD

The present invention relates to a door lock device for a vehicle and more particularly to a door lock device for a vehicle in which a latch mechanism for maintaining a vehicle door in its closed position relative to a vehicle body is operable between an unlocked state where the latch mechanism is operable by an operational handle and a locked state where the latch mechanism is inoperable.

### BACKGROUND ART

A known door lock device for a vehicle, for example, described in JP2001-241248A includes a latch mechanism mounted to a mounting surface at an end portion of the vehicle door for maintaining a vehicle door in its closed position relative to a vehicle body, an operational lever linked to an operational handle provided at the vehicle door and linked to the latch mechanism for operating the latch mechanism in order to release the vehicle door from the vehicle body, a locking lever operable to allow and disallow operable linkage between the operational lever and the latch mechanism, an emergency operational member linked to the locking lever for operating the locking lever, and an electric motor linked to the locking lever via an active lever and for operating the locking lever.

According to the known door lock device for the vehicle, the locking lever is positioned facing the mounting surface at the end portion of the vehicle door, and is approximately T-shaped with a first arm portion and a second arm portion extending in a width direction of the vehicle door. The first arm portion is connected to the active lever and the second arm portion is connected to the emergency operational member.

However, with the construction of the known door lock device for vehicle, because the active lever and the emergency operational member are connected to the first arm portion and the second arm portion respectively and because of the approximately T-shaped configuration of the locking lever, size of the locking lever is increased. Further, because the locking lever faces the mounting surface at the end portion of the vehicle door and the first and the second arm portions extend in the width direction of the vehicle door, size of the vehicle door in the width direction, the door thickness and therefore the weight of the door are increased.

A need thus exists for a door lock device for a vehicle, which includes an active lever and an emergency operational member without increasing size of a locking lever and with relatively simple construction.

### DISCLOSURE OF THE INVENTION

In light of the foregoing, the present invention provides a door lock device for a vehicle, which includes a latch mechanism configured to be fixed to a mounting surface of an end portion of a vehicle door for maintaining the vehicle door in a closed position relative to a vehicle body, said latch mechanism having a latch defining a latch plane; and an operational lever operatively linked to an operational handle provided to the vehicle door and being operatively linked to the latch mechanism for operating the latch mechanism for releasing the vehicle door from the vehicle body and a locking lever arranged perpendicular to the latch plane such that a side surface of the locking lever faces toward the side panel of the vehicle door, the locking lever operable to allow and disallow operable linkage between the operational lever and the latch mechanism; an emergency operational member arranged to face toward the side panel of the vehicle door and operatively linked to the locking lever; an active lever arranged perpendicular to the latch plane such that a side surface of the active lever faces toward the side panel of the vehicle door and including an output shaft that supports the locking lever and the emergency operational member; and an electric motor operatively linked to the active lever for operating the locking lever via the active lever.

### BRIEF DESCRIPTION OF THE DRAWINGS

The foregoing and additional features and characteristics of the present invention will become more apparent from the following detailed description considered with reference to the accompanying drawing figures in which like reference numerals designate like elements.

FIG. 1 is an overview of a vehicle door including a door lock device according to an embodiment of the present invention.

FIG. 2 is a front view of the door lock device according to the embodiment of the present invention.

FIG. 3 is a cross-sectional view taken on line III-III of FIG. 2.

FIG. 4 is a front view showing an open system lever mechanism of a lever unit of the door lock device according to the embodiment of the present invention.

FIG. 5 is a front view showing a locking system lever mechanism of the lever unit of the door lock device according to the embodiment of the present invention.

FIG. 6 is a front view showing an electric motor of the locking system lever mechanism of the lever unit of the door lock device according to the embodiment of the present invention.

FIG. 7 is a cross-sectional view taken on line VII-VII of FIG. 5.

FIG. 8 is a cross-sectional view taken on line VIII-VIII of FIG. 5.

FIG. 9 is a cross-sectional view taken on line IX-IX of FIG. 5.

### BEST MODE FOR CARRYING OUT THE INVENTION

Embodiments of the present invention will be explained with reference to the drawings next.

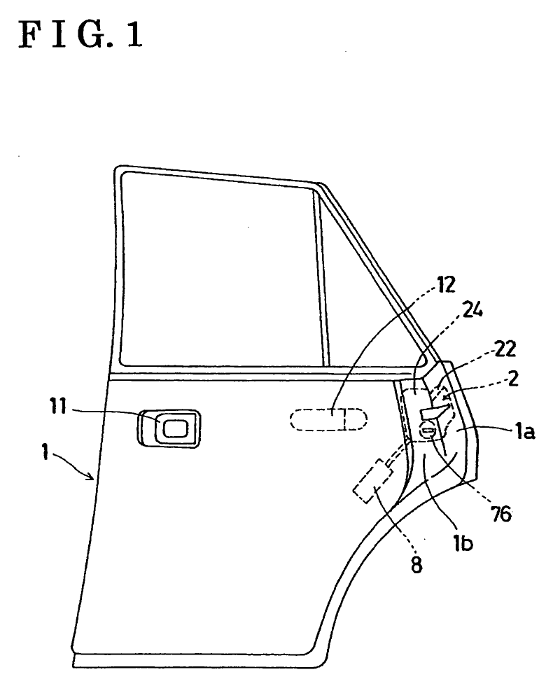

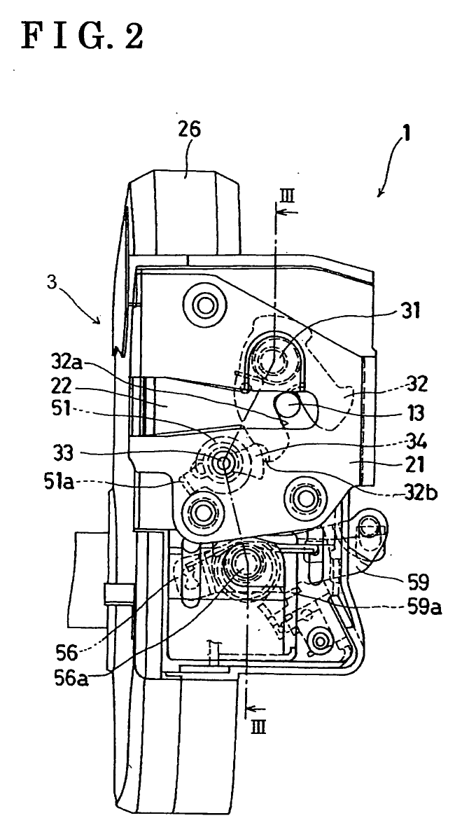

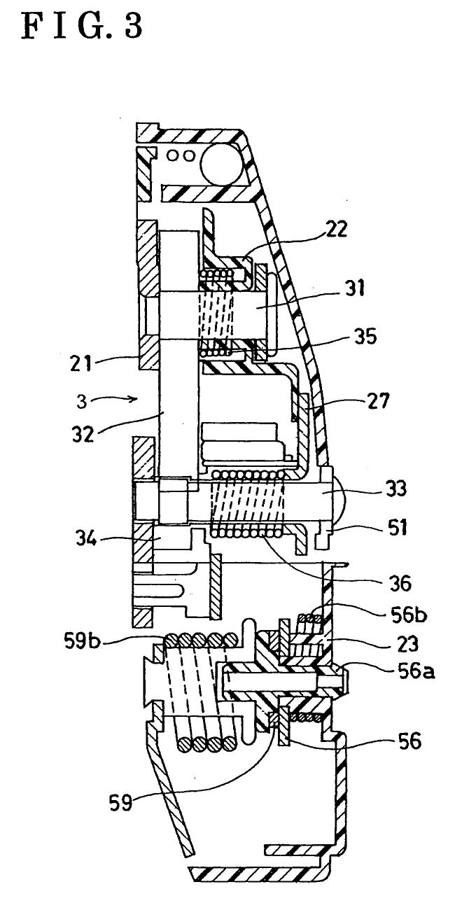

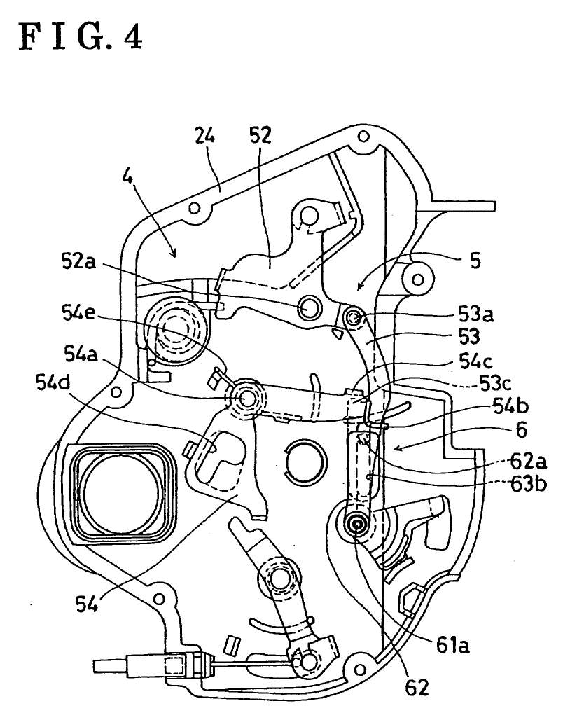

As shown in FIG. 1, a door lock device 2 for maintaining a rear side door 1 (i.e., serving as a vehicle door) of the vehicle in its closed position is fixed to a rear end rim wall 1a (i.e., serving as a mounting surface of an end portion) of the rear side door 1. The door lock device 2 includes a latch mechanism 3 (shown in FIGS. 2-3) configured to be engaged with and disengaged from a striker 13 (shown in FIG. 2) fixed to a vehicle body, and a lever unit 4 (shown in FIG. 4) for operating the latch mechanism 3 so that the rear side door 1 can be opened when either an inside door handle 11 or an outside door handle 12 of the rear side door 1 is operated. The lever unit 4 includes an open system lever mechanism 5 (shown in FIG. 4) for linking the latch mechanism 3 to the inside door handle 11 and to the outside door handle 12, a first locking lever 6 (shown in FIG. 4) configured to unlink the inside door handle 11 and the latch mechanism 3, and a second locking system lever mechanism 7 configured to unlink the outside door handle 11 and the latch mechanism 3.

Construction of the latch mechanism 3 will be explained as follows. As shown in FIG. 2, the latch mechanism 3 includes a latch 32 rotatably supported by a base plate 21 by means of a latch shaft 31 and a pawl 34 rotatably supported by the base plate 21 by means of a pawl shaft 33 arranged in parallel to the latch shaft 31. The latch mechanism 3 is accommodated in a resin body 22 (i.e., serving as a body) attached to the base plate 21 as a unit. A pawl portion 32b configured to be engaged with and disengaged from the pawl 34 and a fitting groove 32a where a striker 13 is inserted to fit in are formed on a face of the latch 32. FIG. 2 shows a latched state of the latch mechanism 3 where the striker 13 is inserted into the fitting groove 32a and the clockwise rotation of the latch 32 in FIG. 2 is restricted by the engagement of the pawl 34 with the pawl portion 32b of the latch 32. Accordingly, the rear side door 1 is maintained its closed position relative to the vehicle body. Upon the clockwise rotation of the pawl 34 in FIG. 2 in the latched state of the latch mechanism 3, the pawl portion 32b of the latch 32 is disengaged from the pawl 34 so that the latch 32 is rotatable clockwise in FIG. 2. In other words, the latch mechanism 3 assumes an unlatched state where the striker 13 is releasable from the fitting groove 32a of the latch 32. Thus, the rear side door 1 can now be opened relative to the vehicle body. The latch 32 is constantly biased in the clockwise direction in FIG. 2 by means of a spring 35. The pawl 34 is constantly biased in the counterclockwise direction in FIG. 2 by means of a spring 36.

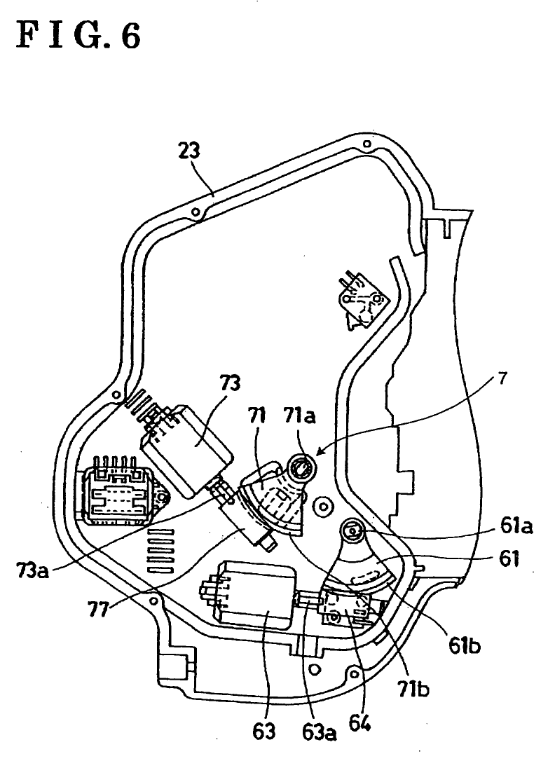

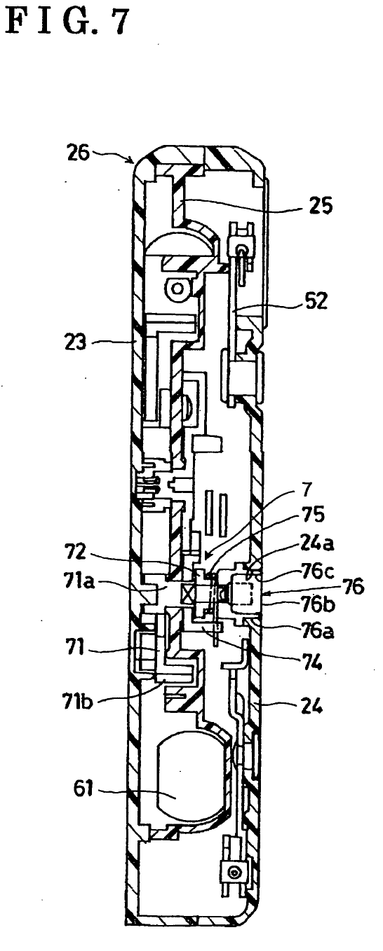

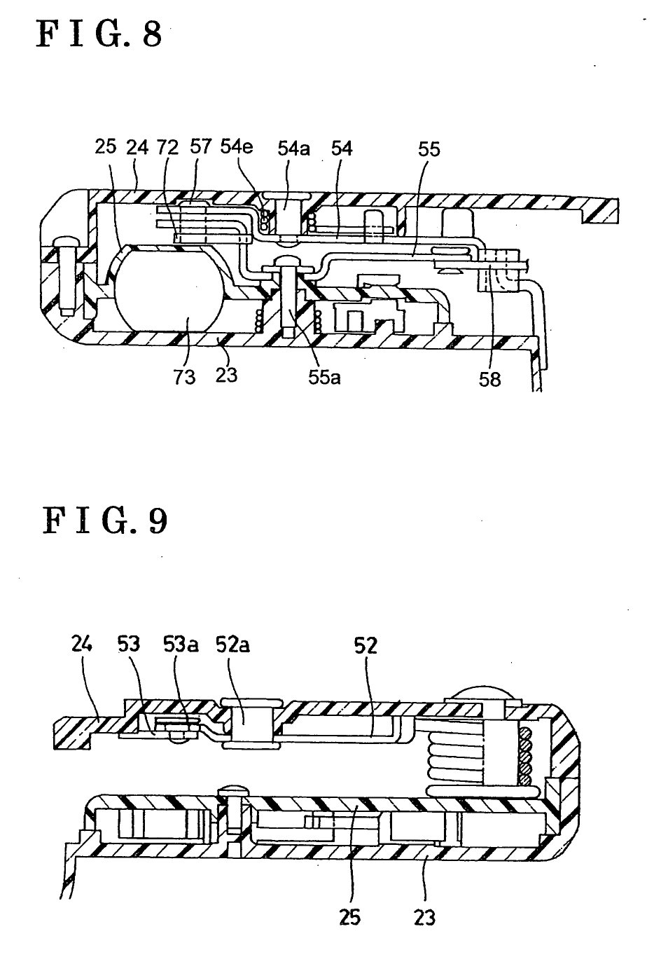

Construction of the open system lever mechanism 5 of the lever unit 4 will be explained as follows. As shown in FIGS. 3-9, the open system lever mechanism 5 is accommodated in a housing 26 having a double layered internal space construction including a case 23, a cover 24, and an intermediate frame 25. The open system lever mechanism 5 includes a lift lever 51, an inside lever 52, an open link 53, a first open lift lever 54, a second open lift lever 55, and an open lever 56 (serving as an operational lever).

As shown in FIGS. 2-3, the lift lever 51 is secured to a pawl shaft 33 so as to rotate in unison with the pawl 34 via the pawl shaft 33. An engagement flange 51a is formed at an end of the lift lever 51 by bending a tip of the lift lever 51.

The inside lever 52 is rotatably supported by a cover 24 of the housing 26 to rotate about a pin 52a. The inside lever 52 is linked to the inside door handle 11 via a cable.

A first end of the open link 53 is rotatably supported by the inside lever 52 via a pin 53a. A long bore 53b for linking the open link 53 to the first locking system lever mechanism 6 is formed on a second end of the open link 53. A contact portion 53c is formed to be projected from the open link 53.

The first open lift lever 54 configured to be approximately L-shaped is rotatably supported by the cover 24 of the housing 26 about a pin 54a. A contact flange 54b which is arranged to contact the engagement flange 51a of the lift lever 51 and an engagement flange 54c which is arranged to contact a contact portion 53c of the open link 53 are formed at a first end of the first open lift lever 54. The first open lift lever 54 is configured to transmit operational force between the open link 53 and the lift lever 51 through contact with the engagement flange 51a and with the contact portion 53c. A irregularly-shaped elongate hole 54d is formed at a second end of the first open lift lever 54.

The second open lift lever 55 configured to be approximately L-shaped is rotatably supported by an intermediate flame 25 of the housing 26 about a pin 55a which is arranged coaxial with the pin 54a. An elongate hole 55b is formed at a first end of the second open lift lever 55, and a slide pin 57 configured to be linked to the second locking system lever mechanism 7 described in detail below is slidably supported at the elongate hole 55b. The slide pin 57 is located in the irregularly-shaped elongate hole 54d of the first open lift lever 54 to be able to contact an inside wall portion of the irregularly-shaped elongate hole 54d. The first open lift lever 54 is linked to the second open lift lever 55 for transmitting the power therebetween through contact between the slide pin 57 and the irregularly-shaped elongate hole 54d.

As shown in FIGS. 2-3, the open lever 56 configured to be approximately L-shaped is supported by a sub base plate 27 supported on the resin body 22 for accommodating the latch mechanism 4 and is rotatably supported about a pin 56a supported by the case 23 of the housing 26. A first end of the open lever 56 is connected to a second end of the second open lift lever 55 via a connection link 58. The open lever 56 is connected to the outside door handle 12 via an outside lever 59 rotatably supported about the pin 56a and a rod (not shown). Operational force is transmitted between the outside lever 59 and the open lever 56 through engagement between an engagement flange 59a formed on the outside lever 59 and the open lever 56. Clockwise rotational force in FIG. 2 is transmitted from the outside lever 59 to the open lever 56 by the engagement between the engagement flange 59a and the open lever 56.

Construction of the first locking system lever mechanism 6 of the lever unit 4 will be explained as follows. As shown in FIGS. 4-9, the first locking system lever mechanism 6 includes an active lever 61, an inside locking lever 62, and an electric motor 63.

The active lever 61 is approximately fan-shaped and is rotatably supported by the case 23 of the housing 26 by means of an output shaft 61a. A toothed portion 61b is formed at a peripheral surface of the active lever 61. A first end of the output shaft 61a of the active lever 61 extends through the intermediate flame 25 of the housing. The inside locking lever 62 is secured to the first end of the output shaft 61a so as to rotate in unison with the active lever 61 via the output shaft 61a. A pin portion 62a is formed projecting from a first end of the inside locking lever 62. The pin portion 62a is inserted into the elongate hole 53b of the open link 53. The electric motor 63 is supported by the intermediate flame 25 of the housing 26, and a worm gear 64 configured to be geared with the toothed portion 61b of the active lever 61 is secured to a rotation output shaft 63a of the electric motor 63. With the foregoing construction, rotation of the inside locking lever 62 due to actuation of the electric motor 63 rotates the open link 53 about the pin 53a, and thus establishes an inside lock state of the lever unit 4 where operational linkage between the open link 53 and the first open lift lever 54 is disallowed and an inside unlock state of the lever unit 4 where operational linkage between the open link 53 and the first open lift lever 54 is allowed.

Construction of the second locking system lever mechanism 7 of the lever unit 4 will be explained as follows.

As shown in FIGS. 4-9, the second locking system lever mechanism 7 includes an active lever 71, an outside locking lever 72 (i.e., serving as a locking lever), an electric motor 73, a sub-locking lever 74, a spring 75, and an operational knob 76 (i.e., serving as an emergency operational member).

The active lever 71 is approximately fan shaped and is rotatably supported by the case 23 of the housing 26 by means of an output shaft 71a. A toothed portion 71b is formed at a peripheral surface of the active lever 71. A first end of the output shaft 71a of the active lever 71 extends through the intermediate flame 25 of the housing 26. The outside locking lever 72 is supported by the outputs shaft 71a to be rotatable about and relative to the output shaft 71a. An arc-shaped elongate hole 72a having the center of arc at the pins 54a, 55a of the first and second open lift levers 54, 55 is formed on the outside locking lever 72. The slide pin 57 is inserted into the arc-shaped elongate hole 72a. The electric motor 73 is supported by the intermediate flame 25 of the housing 26, and a worm gear 77 geared with the toothed portion 71b of the active lever 71 is secured to the rotation output shaft 73a. A sub-locking lever 74 is positioned between the active lever 71 and the outside locking lever 72, and is secured to the output shaft 71a so as to rotate in unison with the active lever 71. The cylindrically formed operational knob 76 is secured to a second end of the output shaft 71a so as to rotate in unison with the active lever 71. A through hole 24a having a diameter corresponding to a diameter of the operational knob 76 is formed at a portion facing the second end of the output shaft 71a. The operational knob 76 is inserted into the through hole 24a, and is supported to be rotatable relative to the cover 24 at an external peripheral surface 76a of the operational knob 76. An end face 76b of the operational knob 76 is exposed outside the cover 24, and an operational bore 76c to which a tool such as a key plate and a driver is fitted in is formed on the end face 76b. The spring 75 is wound around the output shaft 71a between the operational knob 76 and the outside locking lever 72. A first end of the spring 75 is engaged with the outside locking lever 72 and a second end of the spring 75 is engaged with the sub-locking lever 74. The operational knob 76, when secured to the output shaft 71a, prevents the spring 75 from disengaging from the output shaft 71a. With the foregoing construction, the active lever 71, the outside locking lever 72, the sub-locking lever 74, the spring 75, and the operational knob 76 are coaxially arranged on the output shaft 71a.

Upon rotation of the active lever 71 by actuating the electric motor 73 with the foregoing construction, the rotation is transmitted from the output shaft 71a to the sub-locking lever 74 to rotate the sub-locking lever 74. The rotation of the sub-locking lever 74 rotates the outside locking lever 72 via the spring 75. The rotation of the outside locking lever 72 slides the slide pin 57, and thus an outside door unlock state of the lever unit 4 where operational linkage between the first open lift lever 54 and the second open lift lever 55 is allowed, and an outside lock state of the lever unit 4 where the first open lift lever 54 and the second open lift lever 55 are disconnected are established. Upon operation of the operational knob 76, the operational knob 76 rotates relative to the cover 24 on the output shaft 71a, and rotates the output shaft 71a along with the active lever 71 and the sub-locking lever 74. Rotation of the sub-locking lever 74 rotates the outside locking lever 72 via the spring 75, and thus, the outside unlock state and the outside lock state of the lever unit 4 are established.

With the foregoing construction, as shown in FIGS. 2-3, the resin body 22 for accommodating the latch mechanism 3 is assembled to the case 23 of the housing 26 for accommodating the lever unit 4, and thus the door lock device 2 is formed as a unit. In the foregoing state, the housing 26 is arranged perpendicular to the base plate 21 and the sub-base plate 27. The case 23 of the housing 26 covers the sub-base plate 27, the lift lever 51, and the open lever 56. As shown in FIG. 1, the resin body 22 faces the rear end rim wall 1a of the rear side door 1, and the cover 24 of the housing 26 faces an interior side portion panel 1b (i.e., serving as a side panel) of the rear side door 1. The operational knob 76 is covered with a trim covering the interior side portion panel 1b, and can be operated, for example, by removing the trim.

Operation of the door lock device 2 according to the foregoing construction will be explained as follows.

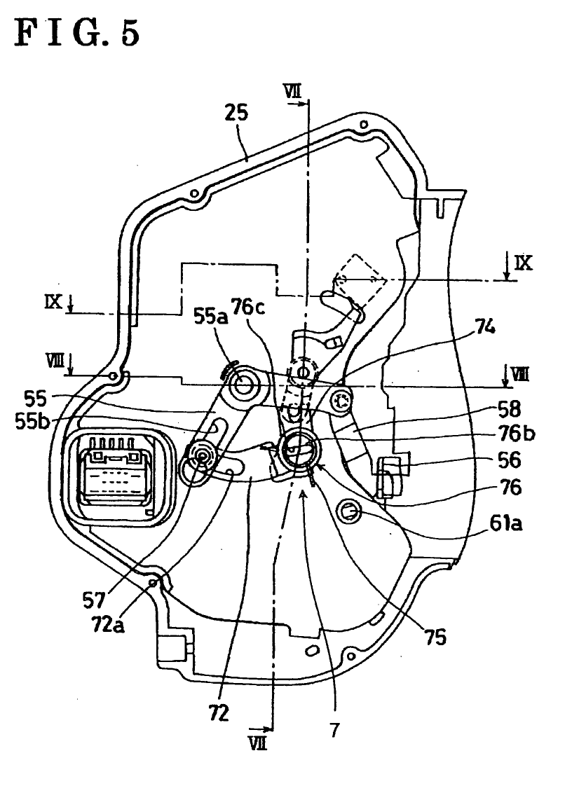

FIGS. 4-9 show the inside unlock state and the outside unlock state of the lever unit 4. At an initial position, the first open lift lever 54 is biased in the clockwise direction in FIG. 4 by the spring 54e. At an initial position, the second open lift lever 55 is biased in the clockwise direction in FIG. 5 by the spring 56b (shown in FIG. 3) for biasing the open lever 56. The inside lever 52 is at an initial position where the inside lever 52 is pulled in the clockwise direction in FIG. 4 by the inside door handle 11. FIG. 2 shows a latched state of the door lock device 2. As shown in FIG. 2, the open lever 56 is biased in the counterclockwise direction in FIG. 2 by a spring 56b to be at an initial position. The outside lever 59 is biased in the counterclockwise direction in FIG. 2 by a spring 59b to be at an initial position.

Upon operation of the outside door handle 12, the outside lever 59 rotates clockwise in FIG. 2 from the initial position (i.e., the position shown in FIG. 2), and the engagement flange 59a of the outside lever 59 contacts the open lever 56 so that the open lever 56 rotates clockwise in FIG. 2 from the initial position (i.e., position shown in FIG. 2). Upon rotation of the open lever 56, the connection link 58 moves upward in FIG. 5, and the second open lift lever 55 rotates counterclockwise in FIG. 5. Upon rotation of the second open lift lever 55, the slide pin 57 contacts the internal wall portion of the irregularly-shaped elongate hole 54d of the first open lift lever 54. Thus, the rotational force of the second open lift lever 55 is transmitted to the first open lift lever 54 to rotate the first open lift lever 54 counterclockwise in FIG. 4, and the contact flange 54b of the first open lift lever 54 contacts the engagement flange 51a of the lift lever 51. Accordingly, the rotational force of the first open lift lever 51 is transmitted to the lift lever 51 to rotate the lift lever 51 clockwise in FIG. 2. Consequently, the pawl 34 rotates clockwise in FIG. 2, and the latch mechanism 3 assumes an unlatched state. In other words, the rear side door 1 can be opened. Because the engagement flange 54c of the first open lift lever 54 is disengaged from the contact portion 53c of the open link 53 by rotating the first open lift lever 54 in the counterclockwise direction in FIG. 4 at this timing, the inside lever 52 does not rotate by the rotation of the first open lift lever 54 upon the operation of the outside door handle 12. That is, the inside door handle 11 does not move in the foregoing operation.

Upon operation of the inside door handle 11, the inside lever 52 rotates from an initial position (i.e., position shown in FIG. 4) counterclockwise in FIG. 4. Upon rotation of the inside lever 52, the open link 53 moves upward in FIG. 4, and the contact portion 53c of the open link 53 contacts the engagement flange 54c of the first open lift lever 54. Thus, moving force of the open link 53 is transmitted to the first open lift lever 54 to rotate the first open lift lever 54 counterclockwise in FIG. 4, and the contact flange 54b of the first open lift lever 54 contacts the engagement flange 51a of the lift lever 51. Accordingly, rotational force of the first open lift lever 54 is transmitted to the lift lever 51 to rotate the lift lever 51 clockwise in FIG. 2. As a result, the pawl 34 rotates clockwise in FIG. 2, and the latch mechanism 2 assumes an unlatched state. That is, the rear side door 1 can be opened. Counterclockwise rotation in FIG. 4 of the first open lift lever 54 rotates the open lever 56 clockwise in FIG. 2 via the slide pin 57, the second open lift lever 55, and the connection link 58. Because the open lever 56 is disengaged from the engagement flange 59a of the outside lever 59 by rotating the open lever 56 clockwise in FIG. 2, the outside lever 59 does not rotate by the rotation of the first open lift lever 54 upon the rotation of the inside door handle 11. That is, the outside door handle 12 does not operate in the foregoing operation.

In case the outside door handle 12 is erroneously operated to open the rear side door 1 when the lever unit 4 is in the outside lock state when actuating the electric motor 73 in order to achieve outside unlock state of the lever unit 4, because a sliding motion of the slide pin 57 is restricted by the internal wall of the irregularly-shaped elongate hole 54d of the first open lift lever 54, the outside locking lever 72 does not rotate, and a shift to the outside unlock state of the lever unit 4 can be restricted. However, the actuation of the electric motor 73 rotates the sub locking lever 74 via the active lever 71 and the output shaft 71a while deflecting the spring 75. Thus, by releasing the operation of the outside door handle 12 after the foregoing operation, the outside locking lever 72 rotates receiving the biasing force of the spring 75, and thus the lever unit 4 is shifted to the outside unlock state. When the outside door handle 12 is operated again, the rear side door 1 can be opened.

According to the embodiment of the present invention, the active lever, the locking lever and the emergency operational member can be coaxially arranged because the locking lever and the emergency operational member are supported by the output shaft of the active lever. Thus, the locking lever does not require arm portions serving as connection portions to the active lever and the emergency operational member, and the locking lever can be reduced in size. Because the locking lever, the active layer, and the emergency operational member are arranged facing toward the side panel of the vehicle door and are perpendicular to the mounting surface of the end portion of the vehicle door where the latch mechanism is fixed or to a latch plane defined by a face of the latch 32, size of the vehicle door in a width direction does not increase. Further, because the emergency operational member faces toward the side panel of the vehicle door, the emergency operational member can be operated irrespective of open and closed state of the vehicle door, and thus the operational performance of the emergency operational member can be improved.

1. a door lock device for a vehicle comprising:
a latch mechanism (3) configured to be fixed to a mounting surface (1a) of an end portion of a vehicle door for maintaining the vehicle door in a closed position relative to a vehicle body, said latch mechanism (3) having a latch (32) defining a latch plane; and
an operational lever (56) operatively linked to an operational handle (12) provided to the vehicle door and being operatively linked to the latch mechanism for operating the latch mechanism for releasing the vehicle door from the vehicle body; characterized by
a locking lever (72) arranged perpendicular to the latch plane such that a side surface of the locking lever (72) faces toward the side panel of the vehicle door, the locking lever operable to allow and disallow operable linkage between the operational lever and the latch mechanism;
an emergency operational member (76) arranged to face toward the side panel of the vehicle door and operatively linked to the locking lever;
an active lever (71) arranged perpendicular to the latch plane such that a side surface of the active lever (71) faces toward the side panel of the vehicle door and including an output shaft (71a) that supports the locking lever and the emergency operational member;
an electric motor (73) operatively linked to the active lever for operating the locking lever via the active lever;
a sub-locking lever (74) connected to a base end of the output shaft to rotate therewith; and
a spring (75) wound around the output shaft between the emergency operational member and the locking lever, a first end of the spring being engaged with the sub locking lever and a second end of the spring being engaged with the locking lever;
wherein the emergency operational member is connected to an end of the output shaft to rotate therewith, and the locking lever is supported to be relatively rotatable about the output shaft.

2. The door lock device for the vehicle according to claim 1, further comprising:
a body (22) for accommodating the latch mechanism; and
a housing (26) mounted perpendicularly to the body for accommodating the operational lever, the locking lever and the electric motor; wherein
the emergency operational member is rotatably supported by the housing such that the emergency operational member rotates coaxially with the locking lever.

3. (canceled)

4. The door lock device for the vehicle according to claim 1, wherein the emergency operational member is secured to the output shaft and prevents the spring from disengaging from the output shaft.

5. The door lock device for the vehicle according to claim 1, wherein the active lever includes a fan shape part that rotates about an axis of the output shaft.

6. The door lock device for the vehicle according to claim 1, wherein the active lever and the locking lever are operable by operating the emergency operational member.

7. The door lock device for the vehicle according to claim 1, wherein the active lever and the locking lever rotate about the output shaft.

8. The door lock device for the vehicle according to claim 1, wherein the sub-locking lever and the spring rotate about the output shaft.
